(19) United States
(12) Patent Application Publication
(10) Pub. No.: US 2012/0094107 A1
(43) Pub. Date: Apr. 19, 2012

(54) ARTIFICIAL SPORTS FIELD INFILL COMPOSITION

(75) Inventors: Kevin S. Spittle, Vero Beach, FL (US); Joe E. Betulius, Naperville, IL (US); Louis W. Ferrara, Wheeling, IL (US)

(73) Assignee: PROFILE PRODUCTS L.L.C., Buffalo Gove, IL (US)

(21) Appl. No.: 13/033,003

(22) Filed: Feb. 23, 2011

Related U.S. Application Data
(60) Provisional application No. 61/308,417, filed on Feb. 26, 2010.

(51) Int. Cl. B32B 3/26

(52) U.S. Cl. 428/304.4

(57) ABSTRACT

In one embodiment, an infill composition includes a resilient material and a porous material including a number of porous particles. In certain instances, the number of porous particles includes porous ceramic particles.

### CROSS-REFERENCE TO RELATED APPLICATION

This application claims the benefit of U.S. provisional Application No. 61/308,417 filed Feb. 26, 2010. The disclosure of which is incorporated herein in its entirety by reference.

### BACKGROUND

1. Technical Field

One or more embodiments of the present invention relate to an infill composition for use in artificial sports or turf fields.

2. Background Art

Artificial turf fields have evolved from presenting tightly woven carpet-like surfaces to having long strands of synthetic fibers stitched onto a backing and an infill material is brushed into the fibers building up a layer over the backing. As the infill is brushed into the synthetic strands, the strands start to become vertical looking like natural grass. The synthetic strands and the backing are laid over gravel or other types of support material to allow drainage of the field after rains. Artificial turf fields are beneficial when excessive play or use is desired. Natural grass fields do not withstand sporting activities and overuse in inclement weather.

### SUMMARY

According to one aspect of the present invention, an infill composition is provided for use in an artificial turf field. In one embodiment, the infill composition includes a resilient material and a porous material including a number of porous particles. In certain instances, the porous material has a bulk density of being no greater than 90 pounds per cubic foot. In certain instances, the porous material includes ceramic particles.

The infill composition optionally includes one or more beneficial bacteria. In certain instances, the beneficial bacterial is provided at an amount of 0.1 to 10 percent by weight of the total dry weight of the infill composition.

The infill composition optionally includes a biocide. In certain instances, the biocide includes copper, zinc, and/or silver. In certain particular instances, the biocide includes copper sulfate.

The infill composition optionally includes a static charge-reducing material. In certain instances, the static charge-reducing material includes carbon black provided at an amount of 0.1 to 15 percent by weight of the total dry weight of the infill composition. In certain other instances, the static charge-reducing material includes iron oxide provided at an amount of 0.1 to 15 percent by weight of the total dry weight of the infill composition.

### BRIEF DESCRIPTION OF THE DRAWINGS

FIG. 1 depicts a cross-sectional view of an artificial turf system according to one or more embodiments; and

FIG. 2 depicts an enlarged cross-sectional view of an infill composition of the artificial turf system of FIG. 1.

### DETAILED DESCRIPTION

Reference will now be made in detail to compositions, embodiments, and methods of the present invention known to the inventors. However, it should be understood that disclosed embodiments are merely exemplary of the present invention which may be embodied in various and alternative forms. Therefore, specific details disclosed herein are not to be interpreted as limiting, rather merely as representative bases for teaching one skilled in the art to variously employ the present invention.

Except where expressly indicated, all numerical quantities in this description indicating amounts of material or conditions of reaction and/or use are to be understood as modified by the word “about” in describing the broadest scope of the present invention.

The description of a group or class of materials as suitable for a given purpose in connection with one or more embodiments of the present invention implies that mixtures of any two or more of the members of the group or class are suitable. Description of constituents in chemical terms refers to the constituents at the time of addition to any combination specified in the description, and does not necessarily preclude chemical interactions among constituents of the mixture once mixed. The first definition of an acronym or other abbreviation applies to all subsequent uses herein of the same abbreviation and applies mutatis mutandis to normal grammatical variations of the initially defined abbreviation. Unless expressly stated to the contrary, measurement of a property is determined by the same technique as previously or later referenced for the same property.

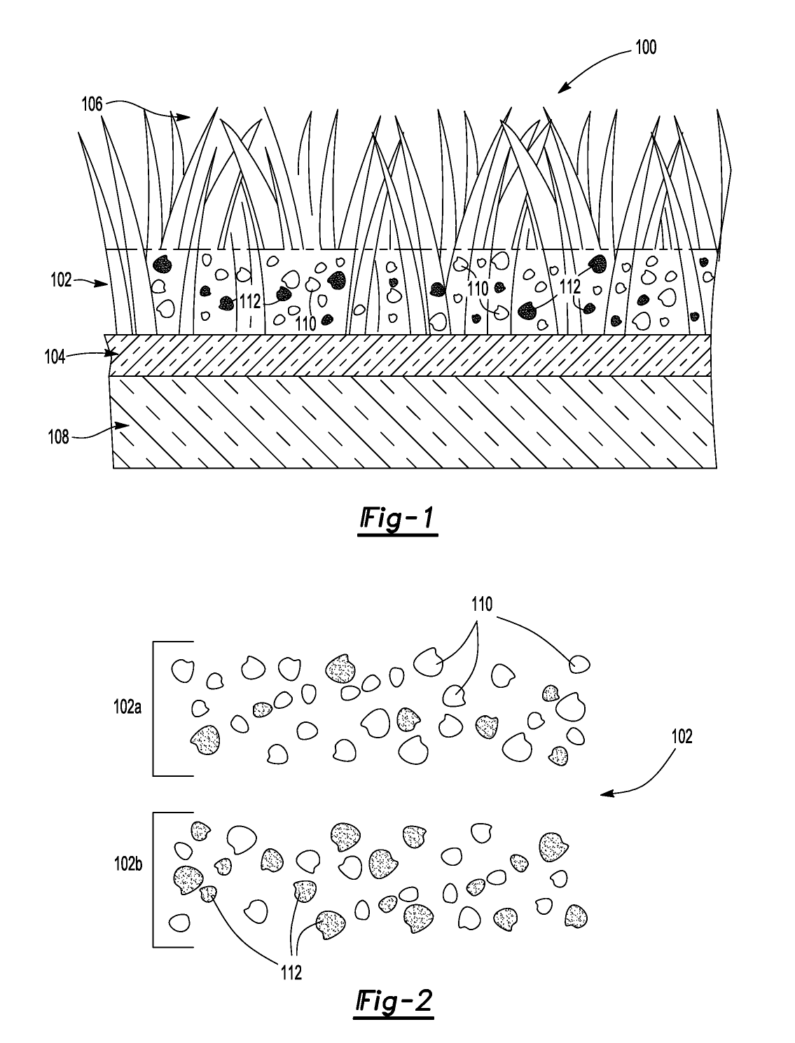

According to one aspect of the present invention, an artificial turf system is provided. In one embodiment, and as depicted in FIG. 1, an artificial turf system generally shown at 100 includes a number of synthetic turf strands 106 supported on a backing layer 104, with an infill composition 102 disposed among the synthetic turf strands 106. Without being limited to any particular theory, it is believed that the infill composition 102 helps keep the synthetic turf strands 106 extending in an upright position from the backing layer 104. The infill composition 102 includes a resilient material 110 and a porous material 112 including a number of porous particles.

In certain instances, the porous material 112 may have a bulk density of no greater than 90 pounds per cubic foot (lb/ft³), no greater than 80 lb/ft³, no greater than 70 lb/ft³, no greater than 60 lb/ft³, or no greater than 50 lb/ft³. In certain particular instances, the porous material 112 may have a bulk density of 15 to 65 lb/ft³, 20 to 60 lb/ft³, 25 to 55 lb/ft³, or 30 to 50 lb/ft³.

In certain other instances, the resilient material 110 may have a bulk density of 10 to 60 lb/ft³, 15 to 55 lb/ft³, 20 to 50 lb/ft³, or 25 to 45 lb/ft³. As a particular non-limiting example of the resilient material 110, crumb rubber has a bulk density of 30 to 35 lb/ft³.

In certain instances, the number of porous porous particles, the number of porous particles having at least one of the following size ranges: 1 to 20 weight percent of the number of porous particles retainable by a size 8 mesh, 70 to 90 weight percent of the number of porous particles retainable by a size 16 mesh, and 5 to 20 weight percent of the number of porous particles retainable by a size 20 mesh. In certain other instances, the number of porous particles have at least one of the following size ranges: 5 to 15 weight percent of the number of porous particles retainable by a size 8 mesh, 75 to 85 weight percent of the number of porous particles retainable by a size 16 mesh, and 10 to 15 weight percent of the number of porous particles retainable by a size 20 mesh. In one or more embodiments, a size 8 mesh may have an average sieve diameter of about 2.38 millimeters; a size 16 mesh may have an average sieve diameter of about 1.19 millimeters; a size 20 mesh may have an average sieve diameter of about 0.84 millimeters; and a size 50 mesh may have an average sieve diameter of about 0.30 millimeters accordingly.

In yet certain other instances, the number of porous particles having at least one of the size ranges: 20 to 50 weight percent of the number of porous particles retainable by a size 8 mesh, 40 to 60 weight percent of the number of porous particles retainable by a size 16 mesh, and 1 to 20 weight percent of the number of porous particles retainable by a size 20 mesh. In yet certain otter instances, the number of porous particles have at least one of the following size ranges: 30 to 40 weight percent of the number of porous particles retainable by a size 8 mesh, 45 to 55 weight percent of the number of porous particles retainable by a size 16 mesh, and 5 to 15 weight percent of the number of porous particles retainable by a size 20 mesh.

A non-limiting particle distribution profile of the porous material 112 may include 6.9 to 7.3 weight percent of porous particles retained by a size 8 mesh, 77.3 to 78.3 weight percent of porous particles retainable by a size 16 mesh, 12.8 to 13.4 weight percent of porous particles retainable by a size 20 mesh, 1.6 to 2.2 weight percent of porous particles retainable by a size 50 mesh, and about 0.1-0.3 weight percent of porous particles retainable by a pan mesh, the sum of the percentages being about 100 weight percent.

A yet non-limiting particle distribution profile of the porous material 112 may include 31.0 to 41 weight percent of porous particles retainable by a size 8 mesh, 45 to 55 weight percent of porous particles retainable by a size 16 mesh, 7.0 to 13.0 weight percent of porous particles retainable by a size 20 mesh, 1.6 to 2.2 weight percent of porous particles retainable by a size 50 mesh, and about 0.1-0.3 weight percent of porous particles retainable by a pan mesh, the sum of the percentages being about 100 weight percent.

The resilient material 110 includes one or more materials that provide certain shock absorbing resilience, and can be formed of natural rubber, synthetic rubber, polymers, thermoplastic elastomers (TPE), foams, and combinations thereof. The resilient material can be fabricated into any suitable shape, for instance, in fibrous, ground, chopped and/or shredded form. In certain instances, the resilient material 110 may include a number of resilient particles, such as rubber particles, polymer particles, foam particles, or any combinations thereof. An non-limiting particle distribution profile of the resilient particles 110 may include 46.9 to 47.9 weight percent of resilient particles retainable by a size 8 mesh, 36.2 to 37.2 weight percent of particles retainable by a size 16 mesh, 11.5 to 12.1 weight percent of resilient particles retainable by a size 20 mesh, 3.6 to 4.2 weight percent of resilient particles retainable by a size 50 mesh, and about 0.1-0.3 weight percent of resilient particles retainable by a pan mesh, the sum of the percentages being about 100 weight percent.

In one or more embodiments, the present invention is advantageous in that the porous material 112 may be provided with a bulk density and/or an average particle size comparable to that of the resilient material 110, such that particle packing, separation, or migration can be effectively reduced. For instance, the particle sizes of the porous material 112 and the resilient material 110 may be selected such that the porous material 112 can blend well with the resilient material 110. For instance, the ratio of an average particle size of the resilient particles to an average particle size of the porous particles is 0.5:1 to 1:0.5, 0.6:1 to 1:0.6, 0.7:1 to 1:0.7, 0.8:1 to 1:0.8, or 0.9:1 to 1:0.9. In certain other instances, the ratio of the first bulk density to the second bulk density is 0.5:1 to 1:0.5, 0.6:1 to 1:0.6, 0.7:1 to 1:0.7, 0.8:1 to 1:0.8, or 0.9:1 to 1:0.9.

For instance also, the infill composition 102 may be substantially free of any sand materials, such as very coarse sand, coarse sand, medium sand, fine sand, or very fine sand. In certain instances, the term “substantially free” refers that the infill composition 102 contains less than 5 weight percent of sand, 2.5 weight percent of sand, 1.0 weight percent of sand, or 0.5 weight percent of sand. In certain particular instances, no sand is intentionally added to the infill composition 102 and any presence of the sand materials would be incidental.

One or more of the above-mentioned benefits, including reduction in particle migration and being substantially free of sand, depart from some conventional sand infill compositions wherein sand tends to separate from the rubber and migrates down through the rubber and settles to the bottom. Separation and migration of sand often observed with the conventional infill compositions causes unwanted laying of the infill and packing of the sand. The packing makes the turf field to become hard and lose requisite resilience. Removal and replacement of the compacted sand is a difficult, time-consuming and expensive process, because the compacted sand layer becomes closely packed together with the artificial upstanding strands and is difficult to remove. Therefore, once packing has occurred in the conventional rubber and sand infill compositions, to reduce or reverse the packing via remixing is nearly impossible without having to disturb or sometimes destroy the integrity of the artificial turf field as a whole.

In one or more embodiments, the present invention is advantageous in that the porous material 112 of the infill composition 102 is believed to be able to hold 7 to 9 times more water than some conventional sand infill compositions. The pore spaces in the porous particles 112 can hold and absorb water from irrigation or rain and slowly release the water as the porous material 112 dries out. This reservoir of water will help lengthen the effect of evaporative cooling of the field. In this regard, the porous particles 112 are provided with a desirable level of porosity to effectively function as a moisture retention material.

In yet another embodiment, the infill composition 102 further includes certain beneficial bacteria (not shown). The beneficial bacteria can be present in any parts of the infill composition 102. In certain instances, the beneficial bacteria are disposed in or around the porous material 112, in or around the resilient material 110, or combinations thereof. In certain particular instances, the beneficial bacteria are disposed within the pore spaces of the porous material 112.

In yet another embodiment, the beneficial bacteria can be supplied to the pore spaces of the porous particles 112, via for instance, impregnation, coating, and/or absorption. The beneficial bacteria can be similar to those found in natural soil. Without being limited to any particular theory, it is appreciated that the beneficial bacterial function to break down pathogens in bodily fluids that are dropped onto the field. When shielded in the pore spaces, the beneficial bacteria are effectively protected from being accidentally washing away by irrigation or rain water. Moreover, release of the beneficial bacteria can be time and amount controlled. The controlled release can be carried out, for instance, by adjusting the pore sizes and/or porosity of the porous material 112. This feature presents a departure from some conventional infill compositions wherein fields must be sprayed with solutions to kill the pathogens, with relatively less release control. In yet another embodiment, the beneficial bacteria are selected from the group consisting of Acidovorax Facilis, Bacillus Licheniformis, Bacillus Oleronius, Bacillus Lentimorbus, Bacillus Marinus, Bacillus Megatorium, Cellulomonas Fimi, Cellulomonas Flavigena, and combinations thereof.

In yet another embodiment, the beneficial bacteria are provided at an amount of 0.1 to 10, 1 to 6, or 2 to 4 percent by weight of the total dry weight of the infill composition 102.

In yet another embodiment, the infill composition 102 further includes a biocide (not shown). The biocide can be present in any parts of the infill composition 102. In certain instances, the biocide is disposed in or around the porous material 112, in or around the resilient material 110, or combinations thereof. In certain particular instances, the biocide is disposed within the pore spaces of the porous material 112.

In yet another embodiment, the biocide includes copper, zinc, and/or silver. In certain instances, the biocide includes copper sulfate.

In yet another embodiment, the biocide is 0.0001 to 5 percent (%), 0.0001 to 0.5%, 0.0001 to 0.1%, or 0.0001 to 0.01% of the total dry weight of the infill composition.

In yet another embodiment, at least a portion of the porous material 112 and the resilient material 110 contains a static charge-reducing material (not shown). In certain instances, the static charge-reducing material is provided as a coating to at least one of the porous materials 112, the resilient materials 110, and a combination thereof. When at least partially coated with the static charge-reducing material, the infill composition 102 may function as a giant conductor to dissipate the static charge build-up. Static charge build-up is common with the use of rubber and synthetic turf blades as these materials are insulating and create static electricity.

Using the static charge-reducing material according to one or more embodiments of the present invention presents a departure from the conventional infill compositions wherein detergent solutions must be periodically sprayed onto the fields to reduce static charge build up. In certain instances, the porous materials are pre-loaded or pre-soaked in water prior to use. When loaded with water, the porous material further helps dissipate static charge build up, and reduces the risk of electrostatic energy discharge.

In yet another embodiment, the static charge-reducing material contains one or more carbon materials, one or more metal oxides, or combinations thereof. Non-limiting examples of the carbon materials include carbon black in powder or granules, carbon gel, and porous carbons. Non-limiting examples of the metal oxides include iron oxide, copper oxide, and magnesium oxide. In certain instances, the static charge-reducing material includes carbon black provided at an amount of 0.1 to 15 percent by weight of the total dry weight of the infill composition. In certain other instances, the static charge-reducing material includes iron oxide provided at an amount of 0.1 to 15 percent by weight of the total dry weight of the infill composition.

The resilient material 110 and the porous material 112 may be mixed together or arranged in layers to form the infill composition 102, with each layer being formed by only one of the materials 110, 112 or by a mixture thereof. In yet another embodiment, and as shown in FIG. 1, the resilient material 110 and the porous material 112 are intermixed. In yet another embodiment, and as shown in FIG. 2, the resilient material 110 and the porous material 112 are configured as two or more layers 102a, 102b, with one of the layers 102 illustratively containing relatively more of the resilient material 110 than the porous material 112 and the other 102b of the layers illustratively containing relatively less of the resilient material 110 than the porous material 112.

The synthetic turf strands 106 can be formed of any suitable synthetic materials such as polyethylene or nylon materials. In certain instances, the synthetic turf strands 106 can be stitched to the backing layer 104. The infill composition 102 can be raked into the turf surface to support the synthetic turf strands 106 to a depth that will support the strands 106. The depth “D” of the infill composition is dependent on the tightness of the strand weave, the length of the strands 106, the type of the strands 106, and intended field use. The entire artificial turf system 100 can be laid down on a support layer 108, which can be formed of crushed stone bases, concrete, soil, gravel, stone, asphalt, smoothed sand, compacted soil, fiber reinforced soil, glass, ceramics, and combinations thereof.

A non-limiting example of the porous material 112 is a porous calcined particle marketed by Profile Products, LLC of Buffalo Grove, Ill., hereinafter Profile Products. Suitable calcined particles are disclosed in Tanner et al., U.S. Pat. No. 6,358,312 entitled “Sports Field Soil Conditioner,” the entire contents thereof are incorporated herein by reference.

In certain instances, the porous particles are a combination of clay components that have been kiln heated or calcined to change the clay to a ceramic mineral state. Without being limited to any particular theory, it is believed that during the calcining process, dehydration of the clay minerals occurs, and the mineral particles coalesce, agglomerate, and densify. Crystal grain growth may occur. The calcined product is cooled slowly, then broken up into generally angular particles or granulates. In certain instances, the porous particles may further be processed to vary in size distribution. In certain other instances, the porous particles may further be de-dusted via optionally pneumatical dedusting.

These porous particles are therefore very different from stone products, such as natural stone nuggets, volcanic stone particles, and sand materials, all of which having a higher bulk density. By way of example, sand is known to have a relatively greater bulk density, such as a bulk density of greater than 90 lb/ft³, greater than 95 lb/ft³, greater than 100 lb/ft³, or greater than 105 lb/ft³.

This process is believed to create capillary and non-capillary porosity inside the porous particles. In certain particular instances, the porous particles can hold over 90% of their weight in water. In other particular instances, the clay based porous calcined particles have a cation exchange capacity (CEC) due to the nature of the raw clay material from which it is made. This allows positive ions to be exchanged on sites on the particle. A non-limiting example of the porous material 112 includes porous ceramic particles under the trade name of Turface MVP®, which is an inorganic mineral having a bulk density of 25 to 42 pounds per cubic foot (lb/ft³). Another non-limiting example of the porous material 112 includes heat treated montmorillonite clay mineral under the trade name of Turface Pro League®, which contains 3 to 5 percent silica.

In one or more embodiments, the term “capillary porosity” may refer to water holding pore space which holds water against the force of gravity and permits the slow release of water back to the soil or surrounding environment as it dries out.

In one or more embodiments, the term “non-capillary porosity” may refer to air pore space that will hold water during an irrigation or rain event, but will drain by gravity. After the particles drain, the non-capillary pores will contain air, while the capillary pores will retain water in them. With both the capillary and non-capillary porosity, the porous particles have a relatively large surface area.

In yet another embodiment, the porous material 112 may be provided with a total porosity in a range of 65 to 85 volume percent, 68 to 82 volume percent, or 71 to 79 volume percent. Of the total porosity, capillary pores may make up about 40 to 60 percent and non-capillary pore make up about 40 to 60 percent, together summing at 100 percent.

In yet another embodiment, the porous material 112 has a total porosity of at least 30 percent, at least 50 percent, and particularly 75 percent. In certain instances, of the total porosity, percentage of the capillary porosity relative to the total porosity is at least 20 percent, 35 percent, or 50 percent.

In yet another embodiment, the porous material 112 contains porous particles formed out of zeolites.

In one or more embodiments, the present invention is advantageous in providing an infill composition that, when applied, has less in wear relative to an existing infill composition based on sand. In certain instances, Applicants' infill composition has 5 to 85 percent reduction in wear, 15 to 75 percent reduction in wear, 25 to 65 percent reduction in wear, or 35 to 55 percent reduction in wear.

Extent of wear may be determined by relative abrasiveness, a property of a synthetic turf which causes material in moving contact with the turf surface to wear away. ASTM F1015-03 “standard test method for relative abrasiveness of synthetic turf playing surfaces” provides a non-limiting example of methods for measuring relative abrasiveness. In brief, friable foam blocks are attached to a weighted platform which is pulled over the playing surface in a prescribed manner. The weight of foam abraded away determines the relative abrasiveness of the surface.

### Example

### Features of a Sample Porous Material

This sample of the porous material 112 described herein can have the following specified features. This sample is formed of porous ceramic particles, manufactured from montmorillinite clay into a ceramic aggregate containing a minimum of 74% porosity (39% capillary, 35% non-capillary). The product is subject to a double kiln process for product stability. The porous ceramic particles contain SiO₂ at 74%, Al₂O₃ at 11%, Fe₂O₃ at 5%, and other chemicals such as CaO, MgO, K₂O, Na₂O and TiO₂ totaling about 5%. The sample has a bulk density of 38±2 lb/ft³.

While the best mode for carrying out the invention has been described in detail, those familiar with the art to which this invention relates will recognize various alternative designs and embodiments for practicing the invention as defined by the following claims.

What is claimed:

1. An infill composition for use in an artificial turf field, comprising:
a resilient material; and
a porous material including a number of porous particles.

2. The infill composition of claim 1, wherein the porous material includes porous ceramic particles.

3. The infill composition of claim 1, wherein the porous material has a bulk density of no greater than 90 pounds per cubic foot.

4. The infill composition of claim 1, wherein the porous material has a porosity of no less than 30 volume percent.

5. The infill composition of claim 1, wherein the number of porous particles have at least one of the following size ranges: 1 to 20 weight percent of the number of porous particles retainable by a size 8 mesh, 70 to 90 weight percent of the number of porous particles retainable by a size 16 mesh, and 5 to 20 weight percent of the number of porous particles retainable by a size 20 mesh.

6. The infill composition of claim 1, wherein the number of porous particles have at least one of the following size ranges: 5 to 15 weight percent of the number of porous particles retainable by a size 8 mesh, 75 to 85 weight percent of the number of porous particles retainable by a size 16 mesh, and 10 to 15 weight percent of the number of porous particles retainable by a size 20 mesh.

7. The infill composition of claim 1, wherein the number of porous particles have at least one of the size ranges: 20 to 50 weight percent of the number of porous particles retainable by a size 8 mesh, 40 to 60 weight percent of the number of porous particles retainable by a size 16 mesh, and 1 to 20 weight percent of the number of porous particles retainable by a size 20 mesh.

8. The infill composition of claim 1, wherein the number of porous particles have at least one of the following size ranges: 30 to 40 weight percent of the number of porous particles retainable by a size 8 mesh, 45 to 55 weight percent of the number of porous particles retainable by a size 16 mesh, and 5 to 15 weight percent of the number of porous particles retainable by a size 20 mesh.

9. The infill composition of claim 1, wherein the infill composition includes less than 5 weight percent of sand.

10. The infill composition of claim 1, wherein the resilient material has a first average particle size and the porous material has a second average particle size, the ratio of the first average particle size to the second average particle size being 0.5:1 to 1:0.5.

11. The infill composition of claim 1, wherein the resilient material has a first bulk density and the porous material has a second bulk density, the ratio of the first bulk density to the second bulk density being 0.5:1 to 1:0.5.

12. The infill composition of claim 11, wherein the ratio of the first bulk density to the second bulk density is 0.7:1 to 1:0.7.

13. The infill composition of claim 11, wherein the ratio of the first bulk density to the second bulk density is 0.9:1 to 1:0.9.

14. The infill composition of claim 1, further comprising one or more beneficial bacteria.

15. The infill composition of claim 14, wherein the one or more beneficial bacteria are of an amount of 0.1 to 10 percent by weight of the total weight of the infill composition.

16. The infill composition of claim 1, further comprising a biocide.

17. The infill composition of claim 16, wherein the biocide includes copper sulfate.

18. The infill composition of claim 1, further comprising a static charge-reducing material.

19. The infill composition of claim 1, wherein the resilient material and the porous material are intermixed.

20. The infill composition of claim 1, wherein the resilient material and the porous material are configured as two or more layers, with one of the layers containing relatively more of the resilient material than the porous material and the other of the layers containing relatively less of the resilient material than the porous material.

21. An infill composition for use in an artificial turf field, comprising:
a resilient material;
a porous material including a number of porous particles, the number of porous particles having at least one of the following size ranges: 1 to 20 weight percent of the number of porous particles retainable by a size 8 mesh, 70 to 90 weight percent of the number of porous particles retainable by a size 16 mesh, and 5 to 20 weight percent of the number of porous particles retainable by a size 20 mesh; and
an additive including at least one of a static charge-reducing material and a biocide,
wherein the infill composition has 5 to 85 percent reduction in wear relative to a counterpart having the porous material replaced with sand in equal amount.

22. The infill composition of claim 22, wherein the number of porous particles have at least one of the following size ranges: 5 to 15 weight percent of the number of porous particles retainable by a size 8 mesh, 75 to 85 weight percent of the number of porous particles retainable by a size 16 mesh, and 10 to 15 weight percent of the number of porous particles retainable by a size 20 mesh.

23. The infill composition of claim 21, wherein the number of particles include porous ceramic particles.

24. An infill composition for use in an artificial turf field, comprising:
a resilient material;
a porous material including a number of porous particles, the number of porous particles having at least one of the size ranges: 20 to 50 weight percent of the number of porous particles retainable by a size 8 mesh, 40 to 60 weight percent of the number of porous particles retainable by a size 16 mesh, and 1 to 20 weight percent of the number of porous particles retainable by a size 20 mesh; and
an additive including at least one of a static charge-reducing material and a biocide,
wherein the infill composition has 5 to 85 percent reduction in wear relative to a counterpart having the porous material replaced with sand in equal amount.

25. The infill composition of claim 24, wherein the number of porous particles having at least one of the following size ranges: 30 to 40 weight percent of the number of porous particles retainable by a size 8 mesh, 45 to 55 weight percent of the number of porous particles retainable by a size 16 mesh, and 5 to 15 weight percent of the number of porous particles retainable by a size 20 mesh.

26. The infill composition of claim 24, wherein the number of porous particles include porous ceramic particles.
